(19) United States
(12) Patent Application Publication
(10) Pub. No.: US 2014/0236708 A1
(43) Pub. Date: Aug. 21, 2014

(54) METHODS AND APPARATUS FOR A PREDICTIVE ADVERTISING ENGINE

(71) Applicant: Nevallco, LLC, Logan, UT (US)

(72) Inventors: Larry Wolff, Scottsdale, AZ (US); Christopher David Chamberlain, Logan, UT (US); Richard Louis Barnett, JR., Las Vegas, NV (US); Rodney Boyd Rosa, Santa Monica, CA (US)

(21) Appl. No.: 14/262,594

(22) Filed: Apr. 25, 2014

Related U.S. Application Data
(63) Continuation-in-part of application No. 13/018,105, filed on Jan. 31, 2011.
(60) Provisional application No. 61/300,209, filed on Feb. 1, 2010.

(51) Int. Cl. G06Q 30/02

(52) U.S. Cl. CPC G06Q 30/0242
USPC 705/14.41

(57) ABSTRACT

Methods and apparatus for a predictive advertising engine may determine a user's likelihood to purchase an advertised item. Methods and apparatus for a predictive advertising engine may retrieve data associated with an advertisement, a content, and a user. The retrieved data may be enhanced, segmented, and sent to predictive modeling software. The predictive modeling software may calculate a score indicating the user's likelihood to purchase the advertised item. The scores may be stored in a first database. The first database may be referenced by the predictive advertising engine to determine which advertisement to deliver to the user. The predictive advertising engine may present a commercial to the user upon user selection of the advertisement, may present a questionnaire to the user upon the user viewing the commercial or selecting the advertisement, and may record the user's answers and interactions to further refine the predictive model.

### CROSS-REFERENCES TO RELATED APPLICATIONS

This application is a continuation-in-part and claims the benefit of U.S. patent application Ser. No. 13/018,105, filed Jan. 31, 2011, entitled SYSTEM FOR SERVING ADVERTISEMENTS THAT ALLOWS COMPENSATION FOR USER VIEWING; which claims the benefit of U.S. Provisional Application No. 61/300,209, filed Feb. 1, 2010, entitled SYSTEM FOR SERVING ADVERTISEMENTS THAT ALLOWS COMPENSATION FOR USER VIEWING; and incorporates the disclosure of each application by reference. To the extent that the present disclosure conflicts with any referenced application, however, the present disclosure is to be given priority.

### BACKGROUND OF THE INVENTION

Current methods for predicting a user's likelihood to purchase an item provide a general idea of what users are likely to purchase based on the content they are watching. For example, users who watch cooking shows may be more likely to purchase home goods compared to users who watch sporting events. This general level of prediction fails to provide an advertiser with the information needed to maximize their advertising campaign, which can lead to a failure to deliver the advertisement to the user group most likely to purchase the item advertised.

### SUMMARY OF THE INVENTION

Methods and apparatus for a predictive advertising engine may determine a user's likelihood to purchase an advertised item. Methods and apparatus for a predictive advertising engine may retrieve data associated with an advertisement, a content, and a user. The retrieved data may be enhanced, segmented, and sent to predictive modeling software. The predictive modeling software may calculate a score indicating the user's likelihood to purchase the advertised item. The scores may be stored in a first database.

The first database may be referenced by the predictive advertising engine to determine which advertisement to deliver to the user. The predictive advertising engine may present a commercial to the user upon user selection of the advertisement, may present a questionnaire to the user upon the user viewing the commercial or selecting the advertisement, and may record the user's answers and interactions to further refine the predictive model.

### BRIEF DESCRIPTION OF THE DRAWING FIGURES

A more complete understanding of the present technology may be derived by referring to the detailed description and claims when considered in connection with the following illustrative figures. In the following figures, like reference numbers refer to similar elements and steps throughout the figures.

FIG. 1 is a block diagram representatively illustrating an exemplary embodiment of a predictive advertising engine and its environment;

FIG. 2 is a block diagram of an ad server and portals of the predictive advertising engine;

FIG. 3 is a block diagram of an ad widget of the predictive advertising engine;

FIG. 4 is a block diagram of a predictive model interface of the predictive advertising engine;

FIG. 5 is a block diagram of a data architecture of the predictive advertising engine;

FIG. 6A is a block diagram of a taxonomy of the predictive advertising engine;

FIG. 6B is an exemplary embodiment of the taxonomy of the predictive advertising engine;

FIG. 6C is an exemplary embodiment of the taxonomy of the predictive advertising engine;

FIG. 7 is a block diagram of hardware and services of the predictive advertising engine;

FIG. 8 is a detailed block diagram of a scoring module of the predictive advertising engine;

FIG. 9 is a block diagram of an Enhance stage of the scoring module;

FIG. 10 is a block diagram of a Describe stage of the scoring module;

FIG. 11 is a block diagram of a Predict stage of the scoring module;

FIG. 12 is a flow chart of the predictive advertising engine;

FIG. 13 is a block diagram of a computing device capable of operating an embodiment of the present invention;

FIGS. 14A-14H are exemplary embodiments of the various database tables used by the predictive advertising engine.

FIG. 15 is a flow chart of a user interaction with the predictive advertising engine.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ systems, technologies, devices, algorithms, designs, services, and the like, which may carry out a variety of functions. In addition, the present technology may be practiced in conjunction with any number of hardware and software applications and environments. For example, the present technology may be practiced in conjunction with any number of websites, software applications, advertising networks, content networks and content feeds, and computing devices such as servers, computer databases, personal computers, and portable computing devices, and the system described is merely one exemplary application for the invention.

Methods and apparatus for a predictive advertising engine according to various aspects of the present technology may operate in conjunction with any suitable computing process or device, interactive system, input system or method, output system or method, and/or telecommunication network. Various representative implementations of the present technology may be applied to any computing device or application configured to communicate via a telecommunication network. Certain representative implementations may comprise, for example, program code stored on any combination of computing devices, wherein the program code facilitates determining a user's likelihood to purchase an advertised item. Various representative algorithms may be implemented with any combination of data structures, objects, processes, routines, other programming elements, and computing components and/or devices.

The present technology may involve multiple programs, functions, computing devices (such as client computers and/or servers), and the like. While the exemplary embodiments are described in conjunction with conventional computing devices, the various elements and processes may be implemented in hardware, software, or any combination of hardware, software, and other systems. Further, the present technology may employ any number of conventional techniques for generating and/or presenting content, interfacing a computing device to a network, transmitting and/or receiving data, providing a user interface, communicating information, interfacing with a user, detecting and/or analyzing input to a computing device, gathering data, tracking advertisement interactions, administering questionnaires, collecting and managing user accounts and information, calculating statistics, and the like.

A computing device may comprise conventional components, such as a processor, a local memory such as RAM, long term memory such as a hard disk, a network adaptor, and any number of input and/or output devices such as a keyboard, mouse, monitor, touch screen, microphone, speaker, motion sensor, orientation sensor, light sensor, and the like. The various memories of the computing device may facilitate the storage of one or more computer instructions, such as a software routine and/or software program, which may be executable by the processor to perform one or more methods, processes, and/or steps of the disclosed technology. A computing device may comprise any suitable device or system such as: a personal computer, server, mobile phone, smart phone, tablet computer, kiosk, portable computer, and the like. Further, databases, systems, and/or components of the present technology may comprise any combination of databases, systems, and/or components at a single location or at multiple locations. Each database, system, and/or component of the present technology may comprise any suitable security features, such as firewalls, access codes, encryption, de-encryption, compression, decompression, and/or the like.

The present technology may be embodied as a method, a system, a device, and/or a computer program product. Accordingly, the present technology may take the form of an entirely software embodiment, an entirely hardware embodiment, or an embodiment combining aspects of both software and hardware. Furthermore, the present technology may take the form of a set of instructions, such as a computer program product, for causing a processor and/or computerized device to perform a desired function, stored on a computer-readable storage medium having computer-readable program code embodied in the storage medium. Any suitable computer-readable storage medium may be utilized, including, but not limited to, hard disks, CD-ROM, optical storage devices, magnetic storage devices, USB memory devices, any appropriate volatile or non-volatile memory system, and the like or any combination thereof. The present technology may take the form of a downloadable and/or cloud-based non-downloadable computer program product and/or methods.

Software and/or software elements according to various aspects of the present technology may be implemented with any programming, scripting, or computer language or standard, such as, for example, AJAX, C, C++, Java, JavaScript, COBOL, assembly, PERL, eXtensible Markup Language (XML), PHP, CSS, etc., or any other programming and/or scripting language, whether now known or later developed. Further, the present technology may be used in conjunction with a computing device running any operating system such as any version of Windows, MacOS, OS/2, BeOS, Linux, UNIX, Android, iOS, or any other operating system, whether now known or later developed.

In addition, the present technology may employ any number of conventional techniques for data transmission, signaling, data processing, network control, and the like. Computing devices according to various aspects of the present technology may communicate with each other by one or more telecommunication networks. The telecommunication network may comprise a collection of terminal nodes, links, and any intermediate nodes which are connected to enable communication (including transfer of data) at a distance between the terminal nodes. In some embodiments, a terminal node may comprise a computing device. The telecommunication network may comprise any suitable communication system, such as the Internet, an intranet, an extranet, WAN, LAN, satellite communications, cellular radio network, wireless network, telephone network, cable network, and the like. Moreover, computing devices according to various aspects of the present technology may communicate over the telecommunication network using TCP/IP, HTTP, HTTPS, FTP, IPX, AppleTalk, IP-6, NetBIOS, OSI, and/or any number of existing or future protocols. The telecommunication network may be simply referred to as a network.

Methods and apparatus for a predictive advertising engine according to various aspects of the present technology may facilitate presenting an advertisement, presenting a commercial in response to a user interaction with the advertisement, and presenting and recording the answer to one or more questions corresponding to the advertisement and/or commercial. Methods and apparatus for a predictive advertising engine may predict the likelihood that a user will buy a product being presented in an advertisement. Methods and apparatus for a predictive advertising engine may facilitate the selection of an advertisement to present to a user based on the predicted likelihood that the user will buy the product being presented.

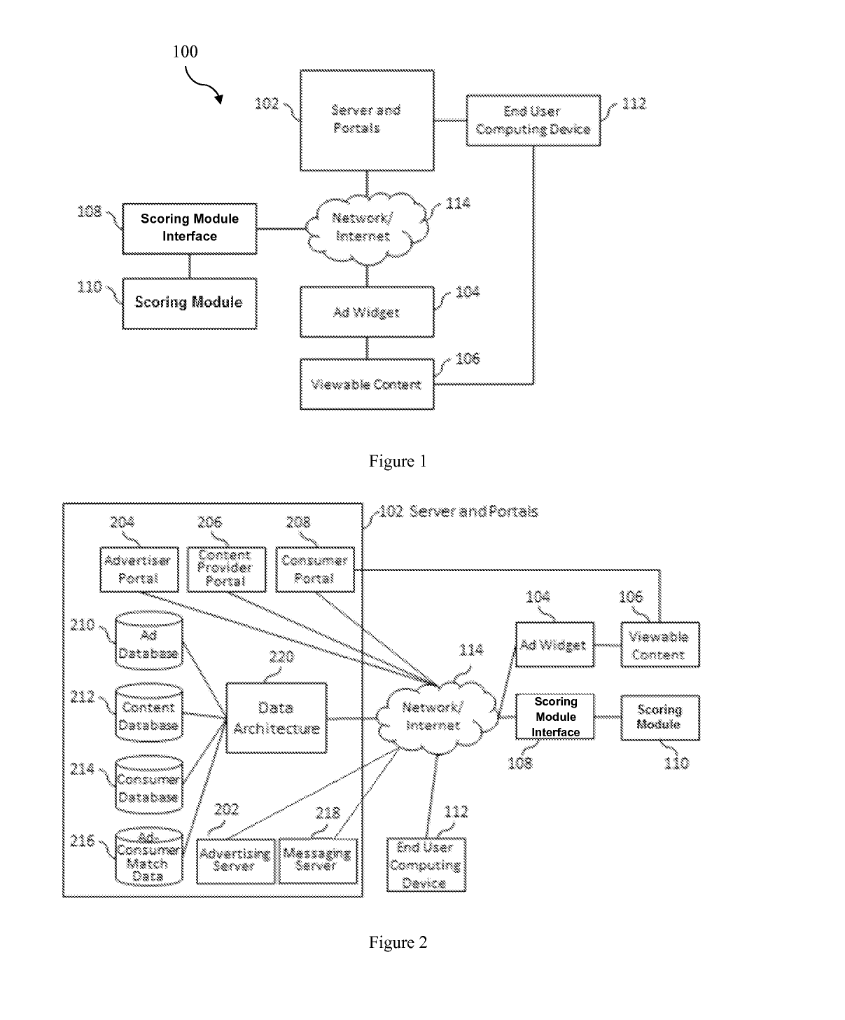

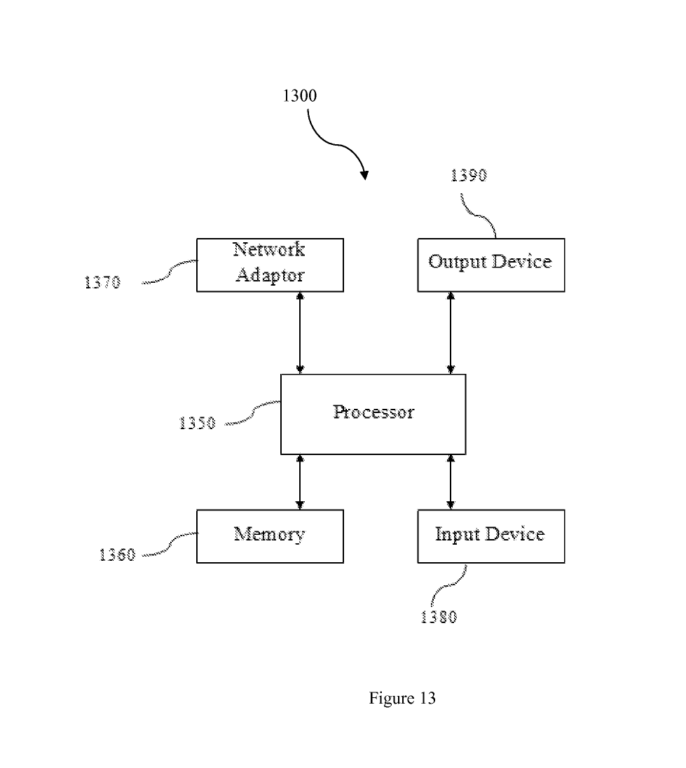

Briefly referring to FIG. 13, the predictive advertising engine may comprise one or more computing devices 1300 comprising conventional components, such as any number of processors 1350 communicatively coupled with any number of memory devices 1360, any number of network adaptors 1370, and any number of input 1380 and/or output 1390 devices such as a keyboard, mouse, monitor, touch-sensitive input device such as touch screen, touch sensor, and the like, microphone, speaker, motion sensor, orientation sensor, light sensor, and the like. A server such as an ad server 202 (shown in FIG. 2) need not comprise an input device 1380 and/or output device 1390. The memory device 1360 may comprise any combination of local memory such as RAM, long term memory such as a hard disk, and the like. The processor 1350 may be configured to access (read and/or write) the memory device 1360.

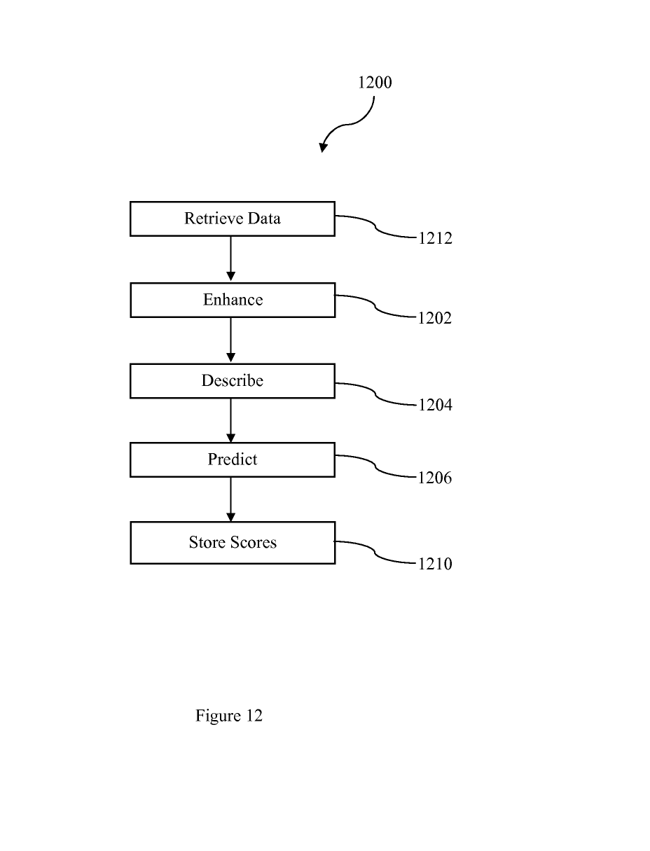

Referring now to FIG. 12, in one embodiment, a method for a predictive advertising engine (1200) may retrieve a plurality of data (1212). The plurality of data retrieved may comprise a first data associated with an advertisement, a second data associated with a content, a third data associated with a user, and/or external data. The advertisement may be an advertisement for a product, service, or a combination of either or the like (which may be referred to as the “advertised item”). The advertisement may comprise more than one advertised item and/or a banner advertisement displayed on a screen of a computing device in combination with other content. The content may comprise content that is displayed on the computing device other than the advertisement. For example, the content may comprise audio and/or visual content from a media source such as YouTube®, Netflix®, Amazon Prime®, ESPN®, and/or any other party capable of creating, generating, transmitting, or otherwise providing content. The content may originate from a third party, an advertiser, the provider of the predictive advertising engine, and the like.

The first data associated with the advertisement (also referred to as “advertisement data”) may comprise data such as the advertisement, information relating to a product, service, and the like advertised in the advertisement (e.g. the advertised item), a commercial and/or questionnaire associated with the advertisement and/or commercial, statistics about the advertisement (e.g., how many times it's been watched, liked, disliked, opted-out, placed in a wish list, etc.), and the like. The commercial may comprise audio and/or visual media that may or may not be related to the product advertised in the advertisement. The first data associated with the advertisement may be retrieved from an advertisement database. In some embodiments, the advertisement data may be retrieved from additional data sources. For example, the advertisement itself may be retrieved from the advertisement database while other advertisement data (e.g., how many times it has been watched, liked, opted-out, etc.) may be retrieved from other data sources, such as the consumer database 214.

The second data associated with the content may comprise descriptive information about the content, such as biographical information, name, description, content rating, genre, cast, duration, timestamps, time slot, director, producer, and the like.

The third data associated with the user may be referred to as the user data. User data may comprise biographical information about the user such as their name, address, and contact information. User data may comprise demographic information. Additionally, user data may comprise the user's activity with the predictive advertising engine such as reward points the user has accrued, what advertisements the user has indicated they wish not to receive (i.e., advertisements the user has opted out of or has shown a negative preference towards), which advertisements the user has liked, which advertisements the user has selected, and the like. The user data may also comprise data related to the user such as a user profile (where the user may indicate their preferences), user activity tracked by the predictive advertising engine (e.g., advertisements, commercials, and questionnaires the user has interacted with), and the like.

In one embodiment, the predictive advertising engine 100 may facilitate the recordation of a user's desired items, services, and the like, for example in the form of a wish list. The user may place one or more items, such as products, services, coupons, cash rewards, and the like, on their wish list. The predictive advertising engine 100 may facilitate the exchange (also referred to as redemption) of reward points by the user for an item on their wish list. The user data may comprise information such as the items the user has placed on their wish list, the items the user has redeemed, the items the user has removed from their wish list without redeeming, and the like.

Referring now to FIGS. 1 and 12, a predictive advertising engine 100 according to various aspects of the present technology may comprise a scoring module 110, one or more interfaces 108, an ad widget 104, and one or more sever and portals 102. The predictive advertising engine 100 may also comprise content 106 and an end user computing device 112. The retrieved first data associated with an advertisement, second data associated with a content, and third data associated with a user may be sent to the scoring module 110, wherein the scoring module 110 may determine the user's likelihood to purchase an item within the advertisement (e.g., the advertised item). As used herein, “purchasing” the advertised item may comprise any suitable exchange for the advertised item, for example the exchange of money, reward points, and the like for the advertised item, a coupon corresponding to the advertised item, and the like.

In determining the user's likelihood to purchase the item, the scoring module 110 may perform subtasks of enhancing the data (1202), describing the data (1204), and calculating a score that represents the predicted likelihood that the user will purchase the advertised item (1206). The calculated score may be stored (1210) in a first database. The predictive advertising engine 100 may select a particular advertisement to be delivered to a user based on the user's likelihood to purchase score for that particular advertisement. After the advertisement has been selected, the predictive advertising engine 100 may transmit the advertisement to the user, for example via the ad widget 104 operating on the end user computing device 112. The transmitted advertisement may be the advertisement itself or an indication of the advertisement.

An indication of the advertisement (or commercial and/or questionnaire, as will be described below) may comprise any suitable data, information, message, or the like for causing and/or facilitating the end user computing 112 device to receive and/or retrieve the advertisement (or commercial and/or questionnaire). For example, if a particular advertisement is selected to be provided to the user, the advertisement itself (i.e., the media that makes up the advertisement) may be provided to the user. A hyperlink to the advertisement may be transmitted instead of the advertisement itself. For example, the predictive advertising engine may provide to the user computing device 112 a link to a separate location where the advertisement is stored. The indication of the advertisement (or commercial or questionnaire) may also comprise other instructions for retrieving the advertisement (or commercial or questionnaire) which may cause a third party and/or database to send the advertisement (or commercial or questionnaire).

Still referring to FIG. 1, the server and portals 102 may be configured to deliver relevant advertisements to users and may include user, advertiser, and content provider portals and various interfaces. The various portals may comprise any suitable system and/or method for facilitating an interaction by an entity with the predictive advertising engine 100. In one embodiment, one or more portals may comprise a web page configured to allow a user to enter and/or manipulate information associated with the user and/or predictive advertising engine 100. A user of the predictive advertising engine, whether the user be a consumer, an advertiser, a content provider, or the like, may have a user account associated with the predictive advertising engine. Such a user account may be referred to as a predictive advertising engine account. The user may access the predictive advertising engine account via one or more of the various portals.

Still referring to FIG. 1, an ad widget 104 may be configured to enable advertisements to be displayed with a content viewing device, website, or the like, and enable user interaction with advertisements. The ad widget 104 may be configured to reward points, products, coupons, money, services, or the like to the user, may be configured to manage reward points, and may be configured to facilitate the redemption of reward points for products, services, and other rewards by the user. Content 106 may comprise any content on or with which advertisements may be displayed. For example, the content 106 may comprise a streaming video, an online game, a Flash® animation, and the like. A scoring module interface 108 may comprise any suitable system or method for providing a bi-directional interface between the scoring module 110 and the ad server and portal 102.

Referring now to FIG. 2, the server and portals 102 may comprise an ad server 202 and an advertiser portal 204. The ad server 202 may comprise any suitable computing device 1300, such as a computer server. An end user computing device 112 may comprise any suitable computing device 1300, such as a personal computer, phone, tablet, television, or any other device on which a user may perceive content. A network 114 may be a public or private telecommunication network, such as the Internet. The ad server 202 may deliver relevant advertisements through the use of the ad widget 104 to the end user computing device 112 via the network 114.

The server and portals 102 may comprise one or more databases configured to store data related to advertisements (advertisement database 210), content (content database 212), consumers/users (consumer database 214), and/or ad-consumer match data (ad-consumer match data database 216). In some embodiments, data may be shared among the various databases 210, 212, 214, 216. In some embodiments, any combination of the various databases 210, 212, 214, 216 may be implemented as a single database. In some embodiments, any of the various databases 210, 212, 214, 216 may be implemented across a plurality of databases. In some embodiments, storing data to one or more of the various databases 210, 212, 214, 216 may comprise storing the data to a table that is linked to the one or more databases 210, 212, 214, 216.

The one or more databases may be implemented using currently existing database schemes such as, but not limited to, IBM DB2, Oracle, MySQL, and/or Microsoft SQL Server. Transferring data to and from the one or more databases may be accomplished using a network connection 114 such as the Internet. The one or more databases may be subject to various data architecture 220 rules such as what data is collected and how the collected data is stored, arranged, integrated, and the manner in which the data will be used. The data architecture 220 may also define the structure and content of the advertisement database 210, the content database 212, the consumer database 214, and the ad-consumer match data database 216. The ad widget 104 as well as the server and portals 102 may send and receive data according to rules defined in the data architecture 220.

In one embodiment, the advertisement database 210 may store advertisements related to a particular good (e.g., basketballs, sports cars, and action movies). The advertisement database 210 may allow advertisements to be added, deleted, and otherwise manipulated via the advertiser portal 204. For example, an advertiser may login to their predictive advertising engine account with the predictive advertising engine 100 through the advertiser portal 204 and make edits to their advertisement content via the portal 204. The advertiser may thereafter decide to remove the advertisement altogether, or modify the advertisement with new content, such as a newer version of an advertisement. The advertiser portal 204 may allow the advertiser to drill down or perform or view other data analysis to see what type of users (consumers) are purchasing a particular product, what other shows or time slots are likely to deliver better results, to perform what-if scenarios to forecast how many consumers will purchase the product if the advertisement is run on different content and/or at different time slots, and the like.

For example, an advertiser may have an advertising campaign with the predictive advertising engine 100 to sell soap. The predictive advertising engine 100 may provide to the advertiser a list of users (or a summary or the like) who have indicated that they have a preference for soap, a list of users (or a summary or the like) who have viewed that advertiser's advertisement, a list of users (or a summary or the like) who have liked the advertisement, watched the commercial, answered the questionnaire, and/or any other statistical information relevant to the advertiser, advertising campaign, advertisement, product, and the like. Given this information, the advertiser may analyze the data and determine the age groups, gender, proximity to major cities, household income, number of children, etc., for those users who are likely and/or not likely to purchase their product. The predictive advertising engine 100 may perform this analysis and make the results viewable by the advertiser. The predictive advertising engine 100 may also provide the advertiser the ability to compare two or more users together to determine which user is more likely than the others to purchase the advertised item.

In one embodiment, the advertisement stored within the advertisement database 210 may be the actual advertisement itself, or a hyperlink to the advertisement. The advertisement database 210 may also store metadata related to the advertisement (the “advertisement metadata”). The advertisement metadata may comprise any suitable information that corresponds to the advertisement, such as the advertisement category, the advertised item, a target demographic, advertiser contact information, other information that describes the advertisement, and the like. For example, the metadata may include the user's response to a series of questions (e.g. a questionnaire) after the user has watched a commercial associated with the advertisement, information about the user's interaction with the commercial associated with the advertisement, and the like. The responses to these questions may later be used by the scoring module 110 to determine the user's likelihood to purchase the advertised item.

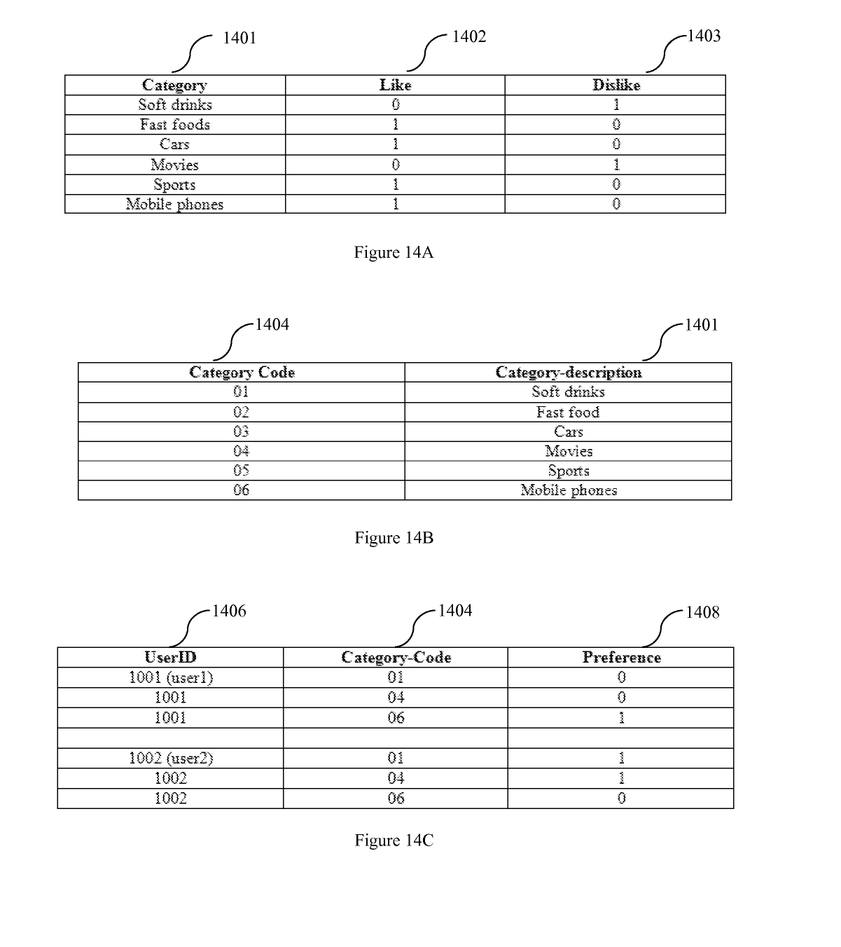

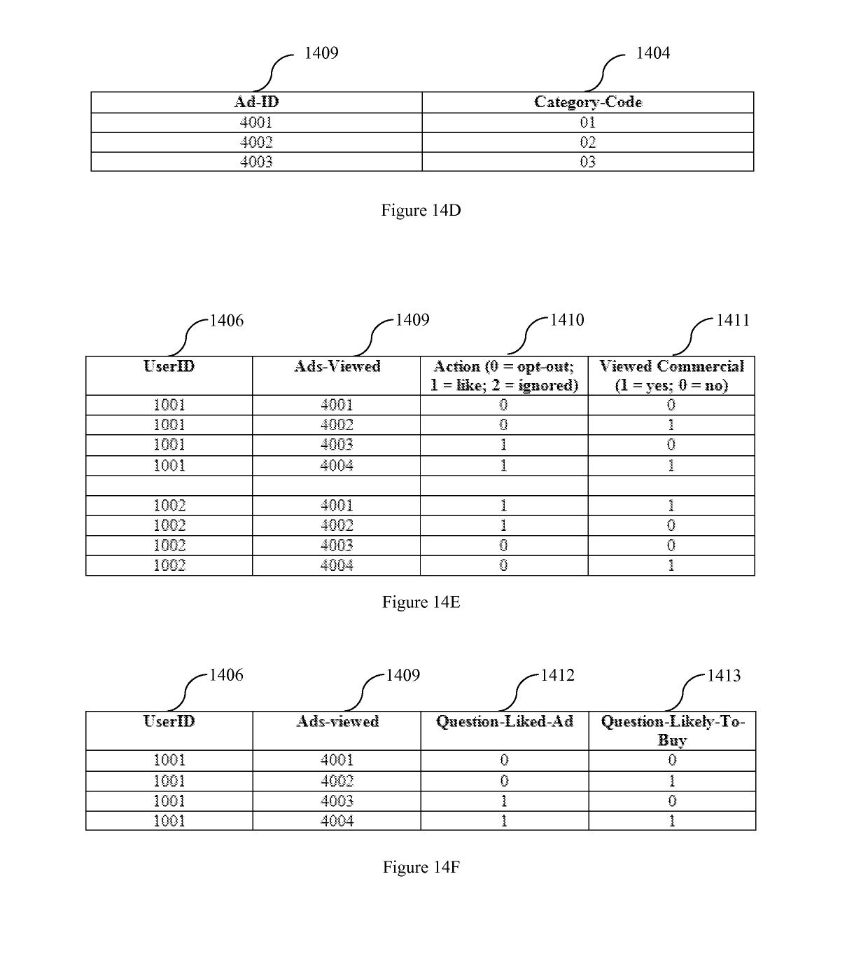

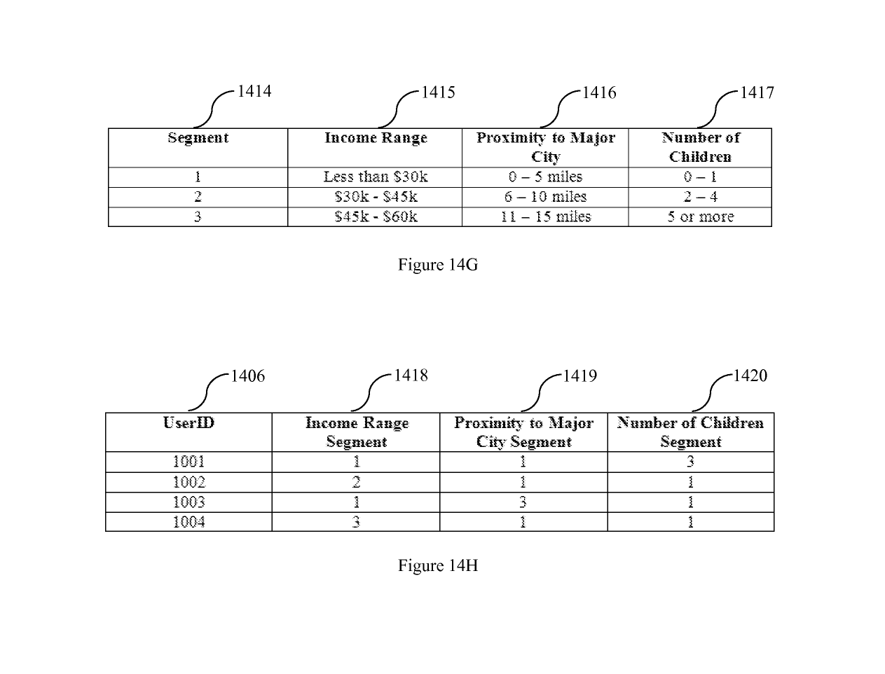

Referring now to FIGS. 14A-H, in one embodiment, the advertisement may be associated with a specific category type. For example, there may be a one-to-one correspondence of category code 1404 to category description 1401. For example the category code “01” may correspond to category description 1401 “soft drinks” whereas category code “02” may correspond to category description 1401 “fast food.” Several advertisements relating to categories such as soft drinks, cars, movies, and the like may be stored within the predictive advertising engine 100. A given category may be further broken down into one or more sub-categories. For example, the category of cars may be further broken down into sub-categories for brands of cars (Honda, Ford, and Mercedes) or types of cars (e.g., trucks, sedans, and vans). Breaking a broad category down into smaller sub-categories may allow the predictive advertising engine 100 to collect and use data at a more granular level, and to provide better analysis and predictions regarding the likelihood of the user purchasing the advertised item.

In one embodiment, the advertisement may be associated with more than one category or sub-category type. An advertisement associated with the category of soft-drinks may at the same time also be associated with the category of cars. For example, the advertisement may contain sounds and images of a person driving a fast sports car while drinking a specific brand of soft drink. The advertiser may opt to specify (e.g. “tag”) their advertisement as both advertising something from the soft drink category as well as the cars category. The advertisement metadata may comprise such a specification.

In one embodiment, the user may indicate, for example via the ad widget 104, that they like the advertisement, may indicate that they would like to opt-out, and/or may ignore the advertisement. For example, a stored value of “0” in the action field 1410 may indicate that the user has selected to opt-out of the advertisement. A value of “1” in the action field 1410 may indicate that the user has liked the advertisement. A value of “2” in the action field 1410 may indicate that the user has ignored the advertisement. When a user indicates that they wish to opt-out of an advertisement, that advertisement will no longer be delivered to the user. The user may still receive other advertisements from the same category or sub-category as the advertisement they chose to opt-out. The user may opt-out of an entire class of categories by indicating that they do not wish to receive advertisements of that category in their user preferences. A user profile may comprise the user preferences as well as other information about the user, such as name, age, gender, and other user data. The user preferences and user profile may be managed via the predictive advertising engine account. For example, if a user indicates in their preferences that they dislike “sports,” then all advertisements containing sports may be blocked from the user. Similarly, the user may indicate in their user preferences that they only dislike a particular sub-category within the sports category (e.g., football, soccer, rugby, etc.), a particular brand, and/or the like.

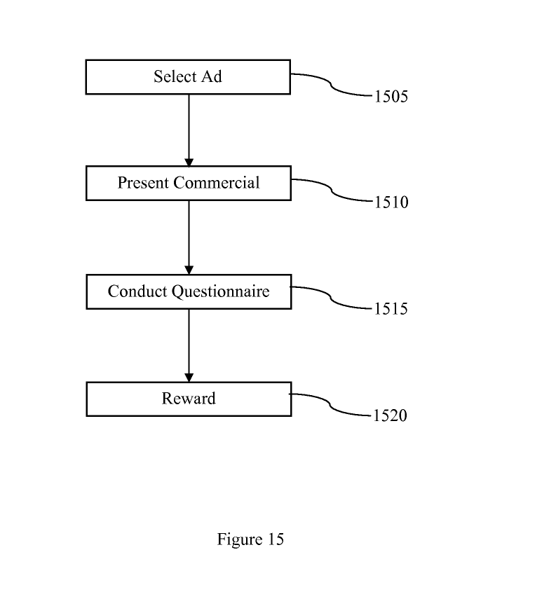

Referring to FIG. 15, in one embodiment, the predictive advertising engine 100 may transmit (1510) a brief (e.g., 30 second) video commercial to be presented to the user after the user has indicated their preference for or otherwise selected (1505) (e.g. by clicking, by pressing a button, and the like) the advertisement. The user may choose, for example via the ad widget 104, to view the commercial immediately upon selecting (1505) the advertisement or at a later time (whether at a predetermined time, after a predetermined duration, at a user-selected time, and the like). The transmitted commercial may be the commercial itself or an indication of the commercial, wherein the indication of the commercial may comprise any suitable data, message, and the like for causing and/or facilitating the end user computing device 112 to receive and/or retrieve the commercial. For example, if the user has indicated that they like an advertisement, then the commercial may be presented to the user. In contrast, if the user has indicated that they dislike the advertisement, ignore the advertisement, or choose to opt-out of the advertisement, then the commercial may not be presented to the user. One or more commercials may be associated with each advertisement. For each commercial, there may be one or more product offers. For example, a soft drink commercial may have a coupon for a $1 off a six-pack and another commercial may contain a $3 off 12-pack. Different coupons (e.g., $1, $5, $20, etc.) may require different amount of reward points to redeem. The product offers may also comprise cash payment to the user.

The predictive advertising engine 100 may conduct a questionnaire (1515) in combination with or separately from presenting a commercial (1510). The questionnaire may comprise one or more questions relating to the commercial and/or the advertisement. The questionnaire may comprise questions such as whether the user liked the commercial and/or advertisement, whether the user is likely to buy the advertised item, and the like. In one embodiment, conducting the questionnaire (1515) may be performed via the ad widget 104. Conducting the questionnaire (1515) may comprise transmitting the questionnaire to the end user computing device 112 and receiving the results of the questionnaire (e.g. the answers, failure to answer one or more questions, and the like). The transmitted questionnaire may be the questionnaire itself or an indication of the questionnaire, wherein the indication of the questionnaire may comprise any suitable data, message, and the like for causing and/or facilitating the end user computing device 112 to receive and/or retrieve the questionnaire.

For example, in one embodiment, conducting a questionnaire (1515) may comprise presenting the questionnaire to the user after the user has completely watched the commercial, and recording the user's responses to the questionnaire. In another embodiment, the predictive advertising engine 100 may conduct a questionnaire (1515) after the user has selected an advertisement (1505), without having to present a commercial (1510) or require that a commercial be fully watched by the user. After the user has watched any required commercial (1510) and answered any required questions (1515), the predictive advertising engine may reward the user (1520), such as with reward points, products, services, coupons, money, and the like. The reward to the user (1520) may be given directly to the user, may be credited to or otherwise associated with a predictive advertising engine account associated with the user, and the like.

In other embodiments, the advertiser may provide shorter or longer commercials for the user to view. The commercials may comprise audio components, visual component, and the like, or any combination thereof. The advertiser may require that the user watch the commercial in order to receive a reward (1520). The amount and/or type of reward associated with a particular advertisement, commercial, and questionnaire combination may be predetermined. For example, an advertiser may set a certain number of reward points for one advertisement while another advertisement may garner more or less reward points. In other embodiments, the amount of reward points may be dynamically calculated. For example, based on the advertisement's history (e.g., how many times it has been viewed, how many times it has been liked/disliked, how many times the associated commercial and/or questionnaire has been viewed/answered, etc.), the predictive advertising engine 100 may dynamically determine if more or fewer reward points, a different type of reward, a more or less valuable coupon, or the like, should be given out.

In one embodiment, the questionnaire may comprise one or more questions for the user to answer or otherwise provide input and/or feedback. The questionnaire may contain questions related to the advertisement and/or commercial. For example, referring now to FIGS. 14F and 15, one question may ask the user whether they liked the advertisement 1412 and another question may ask the user whether or not the user is likely to purchase the item within the advertisement 1413. In one embodiment, the user may accrue reward points (1520) by clicking on an advertisement (1505) and answering questions (1515) from the questionnaire associated with the advertisement.

In one embodiment, the user's interaction with the advertisement, the commercial, and/or the questionnaire may be recorded by the predictive advertising engine 100. For example, a user may select (1505) (click, hover over, or otherwise interact with) an advertisement to view the accompanying commercial (1510). The predictive advertising engine 100 may then update the user's data (such as in the consumer database 214) to indicate that this user has: (1) somehow interacted with the advertisement and/or (2) viewed the commercial associated with the advertisement. If the user goes further and answers the questionnaire associated with the commercial, the predictive advertising engine 100 may then also update the user's data to reflect that the user answered the questionnaire and/or how the user answered the one or more questions.

Referring again to FIG. 2, in one embodiment, the content database 212 may store metadata relating to one or more items of content (“content metadata”) that may be integrated with the ad widget 104. The content metadata may comprise any suitable information that corresponds to the content, such as a category of the content, type of content, format, contact information, genre, other information that describes the content, and the like. The content metadata may exist at one or more levels of granularity. For example, the content metadata may correspond to an episode of a television series, a season of the television series, and/or the entire television series. The content metadata may be added, deleted, and otherwise manipulated via the content provider portal 206. For example, a content provider may login to their predictive advertising engine account through the content provider portal 206 and make edits to their content via the portal. The content metadata may be retrieved from the content database 212 by the scoring module interface 108 which may enable the scoring module 110 to determine what advertisements to deliver to each user viewing any content. The content database 212 may contain an identifier for a particular content provider (e.g., content provider ID), an identifier for the content itself (e.g., content ID), a thumbnail image containing a screen capture of the content, a description of the content (descriptive text, running time, rating, user review, etc.), a link to the content, and the like. The link to the content may allow the content provider to provide the content to various entities (websites, content streaming sites and/or services such as Netflix®, ESPN®, and the like) and/or services.

The consumer database 214 may store information relating to one or more users. In one embodiment, the consumer database 214 may store user profiles, user preferences, user wish list, relevant metadata, and any other suitable user data. The user may use the consumer portal 208 to create and modify a user profile, including providing the predictive advertising engine 100 with their preferences. For example, when the user first initially creates their predictive advertising engine account, they may indicate their preferences (i.e., likes and dislikes) for a variety of categories 1401. The consumer database 214 may also store data related to a user's wish list and the amount of reward points the user has accrued. The user data may be retrieved from the consumer database 214 by the scoring module interface 108 which may enable the scoring module 110 to determine the user's likelihood to purchase an item within the advertisement. The ad-consumer match data database 216 may be populated with data obtained from the scoring module 110 based on information received from the consumer database 214.

In one embodiment, the consumer database 214 may store contact information of the user such as name, address, phone numbers, and email addresses. The consumer database 214 may also store data related to the user's preferences. For example, and referring now to FIGS. 14A and 14C, the user may wish to indicate their preference for certain categories 1401 such as cars, movies, and sports. In one embodiment, the preference may be in the form of a “like” 1402 or a “dislike” 1403. The user's preferences may be linked to the user through their UserID.

In other embodiments, the user may indicate their preference using other metrics such as assigning a number rating (e.g., 1-10) or a sliding scale. The preferences indicated by the user may be stored in a database to be used later by the predictive advertising engine 100 when determining whether to deliver an advertisement. For example, the predictive advertising engine 100 may halt delivery of advertisements related to cars if the user has indicated a dislike or non-preference for that category of advertisements.

Referring now to FIG. 14E, in one embodiment, the consumer database 214 may record other data related to a user. For example, the consumer database 214 may store what advertisements the user has viewed. The predictive advertising engine 100 may store data regarding an action 1410 the user took with respect to the advertisement, such as whether the user opted-out of that advertisement, liked the advertisement, ignored the advertisement, skipped immediately to the commercial, and the like. The predictive advertising engine 100 may also store data regarding whether the user viewed the brief commercial, and/or other information about the user's interaction with the commercial (such as whether the user closed the commercial early, minimized the commercial, re-watched the commercial, and the like).

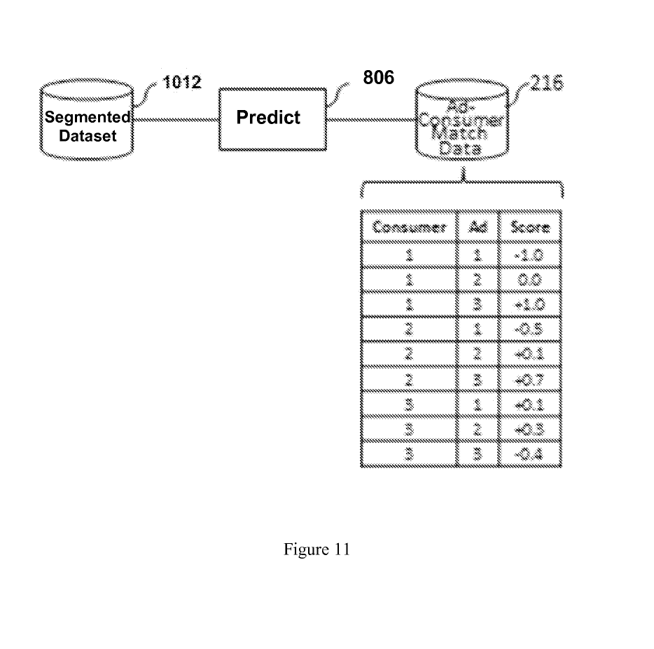

Referring now to FIGS. 10 and 14G, in one embodiment, the consumer database 214 may be linked to one or more segment definition tables. A segment definition table may allow data associated with a user to be further broken down by segment 1414. For example, a segment 1414 may comprise any suitable criteria for grouping a plurality of users, such as “proximity to a major city” 1416, “income range” 1415, “number of children” 1417, and the like. As the predictive advertising engine 100 grows over time with new users and new data to analyze, the segments and/or segment definition table may expand or contract. For example, initially, with less data points to analyze, the income segmentation 1415 may contain broader segments (e.g., income less than $20 k, income between $20 k and $40 k, and income greater than $40 k). Then, as the predictive advertising engine 100 grows with new users and data to analyze, the income segmentation 1415 may be broken down into a more granular level (e.g., income less than $14 k, income between $14 k and $21 k, income between $21 k and $38 k, etc.).

Each segment breakdown may be assigned a unique identifier 1414. For example, income less than $20 k may be assigned a value of “1” and income between $20 k and $40 k may be assigned a value of “2.” The consumer database 214 and/or any other suitable database may contain a list of the users within the predictive advertising engine 100 and their associated segment data, for example which income segment each user is in. As the data accumulated by the predictive advertising engine 100 grows, a new income segment may be determined corresponding to an income of $15 k to $25 k. If that is the case, the predictive advertising engine 100 may then adjust the segment definition table to reflect the change by reassigning a new unique identifier to the income ranges. Therefore, continuing the example, instead of the identifier value of “1” referencing the old less than $20 k range, the new identifier value of “1” may identify the new segment of less than $15 k. The consumer database 214 may them be updated accordingly.

The segment definition table and/or segments may be updated in real time upon storage and/or update of any piece of user data, advertising data, content metadata, and/or external data, at or upon expiration of a predetermined interval such as daily, nightly, etc., once a predetermined amount of data has been stored and/or updated, at a manually determined time, and the like.

In one embodiment, the segment data may be linked to the user data (for example, in the consumer database 214) through the unique user identifiers within the predictive advertising engine 100 (e.g., their user ID) as shown in FIG. 14H. For example, the segmentation column for income ranges 1418 may contain an entry for every user 1406 of the system, and for each user, the predictive advertising engine 100 may assign a segment identifier 1414. For example, user 1001 may have a segment identifier of “1” for the income range segment 1418 and user 1002 may have a segment identifier of “2” for the income range segment 1418. If the predictive advertising engine 100 requires the income range for a particular user, the predictive advertising engine 100 can then reference the income range segment information 1418 according to the specific user's unique identifier (for example, 1001) and find their income segment (for example, “1”). With this information, the predictive advertising engine 100 may then reference the income range segment column 1415 of the segment definition table to determine what income range is associated with segment identifier “1.”

In other embodiments, the segment data may be directly appended to the user data, for example in the consumer database 214. For example, one or more additional data points may be added to the user data within the consumer database 214 to indicate each user's segment data. As the predictive advertising engine 100 grows and adapts to create more granular data points (e.g., tighter income ranges), the user segment data may be automatically updated by the predictive advertising engine 100.

Referring now to FIGS. 2, 8, 11, and 12, in one embodiment, the ad-consumer match data database 216 may be populated and/or updated by the scoring module interface 108 using data generated by the scoring module 110. For example, the predictive advertising engine 100 may retrieve (1212) the user data for a particular user from the consumer database 214 and data relating to one or more advertisements from the advertisement database 210, and may deliver the retrieved data to the scoring module 110 to determine the user's likelihood of purchasing an advertised item of each of the one or more advertisements. As described, determining the user's likelihood of purchasing the advertised item may comprise calculating a score that represents the predicted likelihood that the user will purchase the advertised item (1206).

In one embodiment, the predictive advertising engine 100 may additionally retrieve (1212) data relating to one or more items of content (e.g., content metadata) from the content database 212 and may deliver the additional retrieved data along with the other retrieved data (relating to the user and one or more advertisements) to the scoring module 110 to determine the user's likelihood of purchasing the advertised item of each of the one or more advertisements when viewed in conjunction with each of the one or more items of content, when viewed in conjunction with a content type (e.g. genre), when viewed during a particular time slot, or the like. In other words, the scoring module 110 may determine the likelihood of purchasing an advertised item for each permutation of user, content, and advertisement. Once the likelihood of purchasing an advertised item is determined for the user, that information (e.g. the score) may be stored in the ad-consumer match data database 216 in a manner associated with the user.

In one embodiment, the ad-consumer match data database 216 may comprise three types of information. A first information type may contain data related to identifying the user (e.g., their user ID). A second information type may contain data related to identifying an advertisement (e.g., the advertisement ID). A third information type may contain data related to identifying the user's likelihood to purchase the item associated with the corresponding advertisement (e.g. the advertised item). In one embodiment, the ad-consumer match data database 216 may comprise additional types of information identifying an item of content, a type of content (e.g., genre), a time slot, and the like. The ad-consumer match data database 216 may be pre-sorted. For example, for each user, the advertisements in which the user has the highest likelihood to purchase score may be placed on the top of the queue for that user so when the predictive advertising engine 100 receives a request to deliver an advertisement, the predictive advertising engine 100 may pull the topmost record. This may result in less computational work for the predictive advertising engine 100 and faster advertisement delivery times.

In one embodiment, a likelihood to purchase score for the user may be represented by a number between −1 (very unlikely to buy) and +1 (very likely to buy). The likelihood to purchase number may be further broken down into decimal increments (e.g., −0.2, +0.5, and +0.9). These decimal increments may correspond to a percentage. For example, a likelihood of purchase score of +0.9 for a given user may be interpreted to mean there is 90% likelihood of purchase for that particular given user.

In other embodiments, the ad-consumer match data database 216 may not be ordered. In those cases, the predictive advertising engine 100 may run a particular algorithm or procedure on the data to select which particular advertisement to deliver to the user. For example, in an unsorted ad-consumer match data database 216, the system may select the most current advertisement that meets a certain score threshold. The predictive advertising engine 100 may also select the oldest yet-to-be-delivered advertisement associated with a particular user. Delivery of this yet-to-be-delivered advertisement may still adhere to the minimum score threshold.

Referring again to FIG. 2, in one embodiment, the ad server and portal 102 may also comprise various portals for the different types of entities that use the predictive advertising engine 100. The advertiser portal 204 may comprise any suitable system or method for inputting and/or receiving data to and/or from the predictive advertising engine 100. For example, the advertiser portal 204 may comprise a software application or website for advertisers to manage their accounts and advertisement campaigns. The advertiser portal 204 may also allow advertisers to view analytic information related to their campaigns. The advertiser portal 204 may send and receive data to and from the advertisement database 210 via the network 114.

In one embodiment, the advertiser may use the advertiser portal 204 to update information relating to their advertisements. The advertiser may add new advertisements, remove old ones, adjust reward points associated with the advertisements, adjust the questionnaires associated with the advertisements, view statistics related to their advertisements such as how many times it has been liked, ignored, and/or opted-out of, create and/or update advertisement metadata, and the like.

A content provider portal 206 may comprise a software application or website for content providers to manage information relating to content 106 and to view analytics regarding their content. In one embodiment, the content provider may use the content provider portal 206 to update information relating to the content being provided such as ratings, reviews, durations, metadata, and the like.

A consumer portal 208 may be provided by the predictive advertising engine 100. The consumer portal 208 may comprise a software application or website for consumers to register as well as manage their profiles, wish lists, redeem points for products, services, coupons, and the like, and find/navigate to content. In one embodiment, the user may use the consumer portal 208 to indicate their preferences on various categories. For example, referring now to FIG. 14A, the user may wish to indicate that they have a preference 1402, 1403 for the category 1401 of “cars” and they do not have a preference for the category of “soft drinks” These preferences may be used later by the scoring module 110 in determining the user's likelihood to purchase an item.

An ad server 202 may be configured to deliver advertisements to the ad widget 104 via the network 114. In one embodiment, the ad server 202 may actively retrieve data related to an advertisement from the ad-consumer match data database 216. The retrieved data related to an advertisement may correspond to the next advertisement to show to the user. The ad server 202 may send the advertisement corresponding to the retrieved data, via the network 114, to the ad widget 104. In another embodiment, the ad server 202 may send an identifier (such as an indication of the advertisement) to the ad widget 104. The identifier may be used to specify which advertisement to be delivered. For example, the identifier may be the ID associated with that particular advertisement. The ad widget 104 may then use that identifier to retrieve the advertisement. The ad widget 104 may then present the advertisement via the end user computing device 112. The ad server 202 may be implemented in a variety of ways including, but limited to, OpenX, Atlas, AdTech, or any proprietary software.

In one embodiment, the ad server 202 may receive data related to an advertisement (e.g., which advertisement to deliver and to which user to deliver the advertisement to) from the predictive advertising engine 100. The data related to an advertisement from the predictive advertising engine 100 may be selected or otherwise based on the likelihood to purchase scores from the ad-consumer match data database 216. The ad server 202 may deliver the advertisement (or an indication thereof) based on the received data related to the advertisement to the ad widget 104 which may, in turn, present (e.g. play, display, and the like) the advertisement to a consumer. The data received from the ad-consumer match data database 216 may include information that was determined using the scoring module 110. Predictive advertisement placement may enable the predictive advertising engine 100 to deliver more precise and effective advertisements to consumers.

Referring again to FIG. 2, in one embodiment, a messaging server 218 may be configured to send email, text messages, and the like, to targeted consumers, advertisers, and content providers. For example, when a consumer redeems an item on their wish list by exchanging reward points for the item via the end user computing device 112, the ad widget 104 may send a transaction to messaging server 218 via the network 114 instructing the messaging server 218 to send an email or text message with information relating to the selected reward, such as a coupon, instructions for receiving the reward, and the like. The messaging server 218 may comprise a computing device 1300. In one embodiment, the messaging server 218 may be implemented using any commercially available messaging server subject to any capacity, speed, and security requirements.

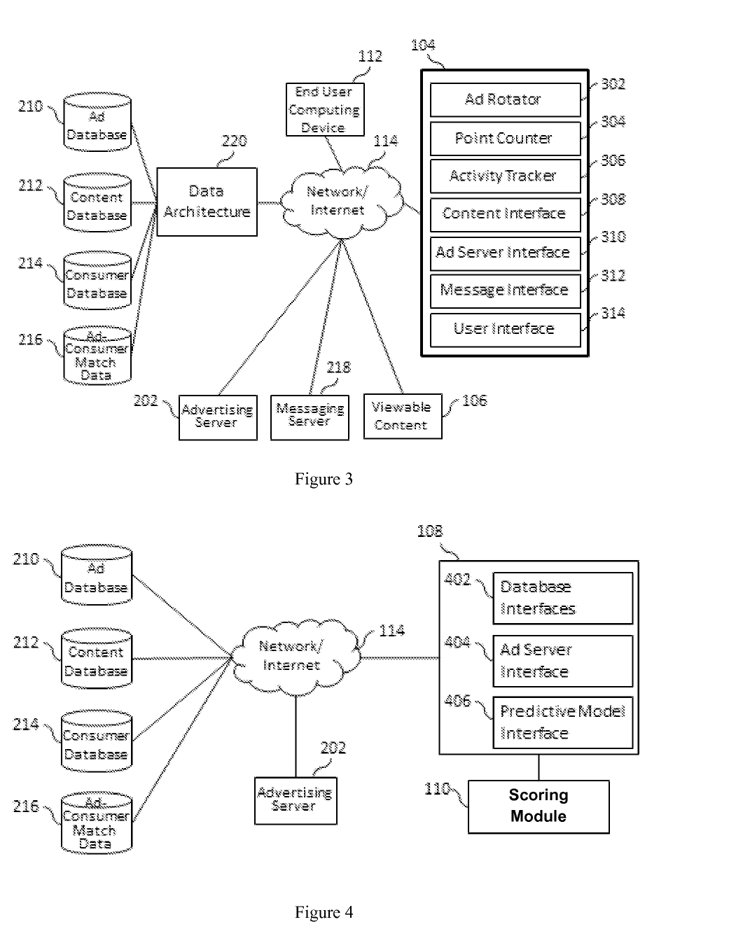

Referring now to FIG. 3, the ad widget 104 may enable advertisements to be displayed alongside content via an ad rotator 302. Additionally, the ad widget 104 may enable the tracking and storing of user interactions with advertisements and a point counting system 304 for the tracking and storing of user reward points. The ad widget 104 may also be configured to receive advertisements via the ad server 202, send messaging transactions to a messaging interface 312, and display data on and receive instructions from the end user computing device 112 with a user interface module 314. The ad widget 104 may also comprise a content interface 308 configured to connect the ad widget with content to be presented.

The ad rotator 302 of the ad widget 104 may comprise any suitable system or method for presenting advertisements. The ad rotator 302 may be configured to receive advertisements from the ad server 202 and present them on the end user computing device 112. In one embodiment, the ad rotator 302 may be called on or otherwise configured to retrieve an advertisement for a user. The ad rotator 302 may request an advertisement from the ad server 202. The ad server 202 may deliver an advertisement to the ad rotator 302 based on the ad-consumer match data database 216. For example, the ad server 202 may, for a given user (and possibly a given content), reference the ad-consumer match data database 216 for the user (and possibly the content) to determine which advertisement to deliver to the ad rotator 302. If, for example, the ad-consumer match data database 216 is ordered by highest likelihood to purchase scores, the top-most advertisement in the ad-consumer match data database 216 for the particular combination of user and content may be selected as the advertisement to deliver.

The point counting system 304 may track reward points associated with a particular user. The point counting system 304 may receive a user point total from the consumer database 214 at the start of a user session. The user point total may be displayed on the end user computing device 112 and the point total may be updated each time the user interacts with an advertisement via the end user computing device 112, may be updated upon a predetermined action such as completing a questionnaire, may be updated when the user redeems points, and/or the like. The user may earn reward points a variety of ways, such as clicking (or otherwise selecting and/or interacting with) an advertisement, watching the commercial associated with the advertisement, answering a questionnaire associated with the commercial, and the like.

In another embodiment, reward points earned by the user may be stored in a separate database which is linked to the user. For example, there may be a separate database which contains a list of users and the amount of reward points associated with that user. The database may be updated as the user accrues additional reward points. Likewise, the database may be updated as the user loses points by exchanging and/or redeeming their reward points for items, coupons, money, and the like. The database may be updated in real-time or can be updated at or upon expiration of a predetermined interval of time.

In one embodiment, the user may acquire reward points by watching the commercial associated with an advertisement and answering the questionnaire associated with the commercial. For example, the user may see that the advertisement contains the new car that the user has been thinking about purchasing. The user may indicate that they “like” the advertisement by clicking or otherwise selecting the advertisement. Thereafter, the user may be shown a brief commercial. In other embodiments, the user may proceed to the commercial in a manner other than clicking the advertisement. For example, the user may hover over the advertisement for a certain, possibly predetermined, amount of time to indicate to the predictive advertising engine 100 that they wish to proceed. In one embodiment, a commercial may not be shown upon selection of the advertisement, and the questionnaire may be associated directly with the advertisement.

In other embodiments, the user may indicate that they “like” an advertisement without indicating that they wish to watch the commercial. For example, the user may like the style of the banner advertisement that is shown to them, but have no particular interest in the actual item advertised. The user may still indicate to the predictive advertising engine 100 that they like the advertisement (and therefore the predictive advertising engine 100 can provide analytics and metrics to the advertiser), for example via a “like” button displayed in conjunction with the advertisement, without having to watch the commercial or answer the questionnaire associated with the commercial.

In one embodiment, the ad widget 104 may present a questionnaire associated with the commercial prompting the user to answer a series of questions related to the commercial they just watched. Upon the completion of the questionnaire, the predictive advertising engine 100 may reward the user with a predetermined amount of reward points. In one embodiment, the amount of reward points may be determined and/or predetermined by the advertiser, for example based on their own metrics. The reward points may also be determined by other entities using the predictive advertising engine 100 such as the user, the content providers, and/or the provider of the predictive advertising engine 100, any combination thereof, or any combination thereof including the advertiser.

In one embodiment, the user may exchange reward points for rewards by placing an item into their wish list and later claiming that item. For example, a user may place a basketball on their wish list, and, if the user has sufficient reward points the user may exchange the required amount of reward points for the basketball, a coupon for the basketball, and the like. An item in the wish list may be claimed using a check-out system. For example, after the user has selected the item they wish to redeem, they may complete the exchange by clicking a button or similar action. The predictive advertising engine 100 and its various components may then perform functions to determine whether the user has sufficient reward points associated with their account, whether the item is in stock, and the like. An item may include, but is not limited to a physical item, a voucher which is redeemable for physical goods, credits that may be exchanged at merchants for goods or services, coupons, money, or any other item.

In other embodiments, the user may acquire reward points from interacting with the advertisement irrespective of answering a questionnaire. For example, the user may acquire reward points based on the number or frequency of unique advertisements selected and/or commercials watched. The reward points may be variable. For example, the amount of reward points to be given for a particular advertisement may depend on the number of times the advertisement has been selected, the frequency of selection, and/or the feedback from users who have selected the advertisement. In addition, the amount of reward points to award a user may depend on the category of products advertised within the advertisement, the time of the year, and other promotional considerations. In other embodiments, the user may redeem reward points by going to a “reward store.” For example, an advertiser (or any other entity using the predictive advertising engine 100) may provide to the user a list of available items that can be redeemed. The user would then have the option to select from the predetermined list of available redeemable goods and/or services. The predictive advertising engine 100 may then facilitate the exchange of reward points for the goods and/or services selected by the user. In some embodiments, goods and/or services may be automatically rewarded to the user. For example, once the user has accrued a specific number of points, the predictive advertising engine may automatically reward the user (e.g., with a coupon, bonus reward points, etc.).

In one embodiment, the activity tracking system 306 may track data associated with advertisement displays, user interactions with the advertisement displays, and may send the tracked data back to the server and portals 102. The activity tracking system 306 may send a transaction to the advertisement database 210 each time an advertisement is presented on the end user computing device 112 via the ad rotator 302. For example, the activity tracking system 306 may send to the advertisement database 210, content database 212, and/or consumer database 214 data such as what advertisement the user watched, whether or not the user clicked the advertisement, what content was being viewed at the time of interaction, whether the user watched the brief commercial, whether the user answered questions related to the commercial, whether the user liked the commercial and/or advertisement, whether the user indicated they are likely to purchase the item within the advertisement, and the like.

Additionally, the activity tracking system 306 may track when a user initially signs up for the predictive advertising engine 100 and when the user has signed in and out of the predictive advertising engine 100. The activity tracking system 306 may also track preferences the user selected in their user profile. The activity tracking system 306 may also track whether the user liked or disliked the advertisement, items the user has placed on their wish list, and what items the user redeemed using their reward points. The activity tracking system 306 may track the advertisement impressions. For example, the predictive advertising engine 100 may track the position of the advertisement as it sits on a computing device, the URL of the entity which referred the advertisement, and/or a timestamp indicating when the advertisement was displayed and/or how long it was displayed for.

The activity tracking system 306 may also send a transaction to the content database 212, and/or the consumer database 214 each time a consumer interacts with an advertisement displayed by the ad rotator 302 on the end user computing device 112. One example of an interaction by the consumer may be opting into an advertisement, opting-out of an advertisement, liking an advertisement, disliking an advertisement, and ignoring an advertisement. When the consumer indicates that they wish to opt-in to an advertisement, this choice may be stored by the activity tracking system 306 into the advertisement database 210 to show that the consumer has indicated they wish to view that advertiser's content. The same opt-in choice made by the consumer may be additionally or alternatively stored by the activity tracking system 306 into the consumer database 214. This would allow the predictive advertising engine 100 to recognize that this particular consumer has indicated their preference for a specific advertisement.

The activity tracking system 306 may also track the user's interactions with both the commercials associated with the advertisements and the questionnaires associated with the commercials. For example, the activity tracking system 306 may track whether the user has indicated they like or dislike a commercial and whether the user has indicated that they are likely to purchase the item within the advertisement. The activity tracking system 306 may also track whether the user has completed the questionnaire.

The activity tracking system 306 may also send a transaction to the message interface 312 based on the user's selection. For example, if the user has indicated they wish to claim an item using their reward points, then the activity tracking system 306 may indicate this information to the message interface 312 which may then send a message to the user using the messaging server 218. The message interface 312 may send message transactions to the messaging server 218. The message interface 312 may receive a transaction from the activity tracking system 306 and send information to the messaging server 218.

The content interface 308 may include hardware and/or software interfaces to allow the ad widget 104 to connect with the content 106. The content interface 308 may connect the ad widget 104 with the content 106 via direct or indirect connection.

The ad widget 104 may also comprise an ad server interface 310 that may be configured to receive advertisements from the ad server 202 and send the advertisements to the ad rotator 302. The ad server interface 310 may receive advertisements via a pull or push technology from the ad server 202 and deliver them to the ad rotator 302 for presentation on the end user computing device 112.

The user interface module 314 may display data on, and receive instructions from, the end user computing device 112. The user interface module 314 may display data from the ad rotator 302 onto the end user computing device 112. The user interface module 314 may accept user commands from the end user computing device 112 (for example, in response to a user input) and deliver them to the ad rotator 302 and/or the activity tracker 306. The user interface module 314 may authenticate end user credentials.

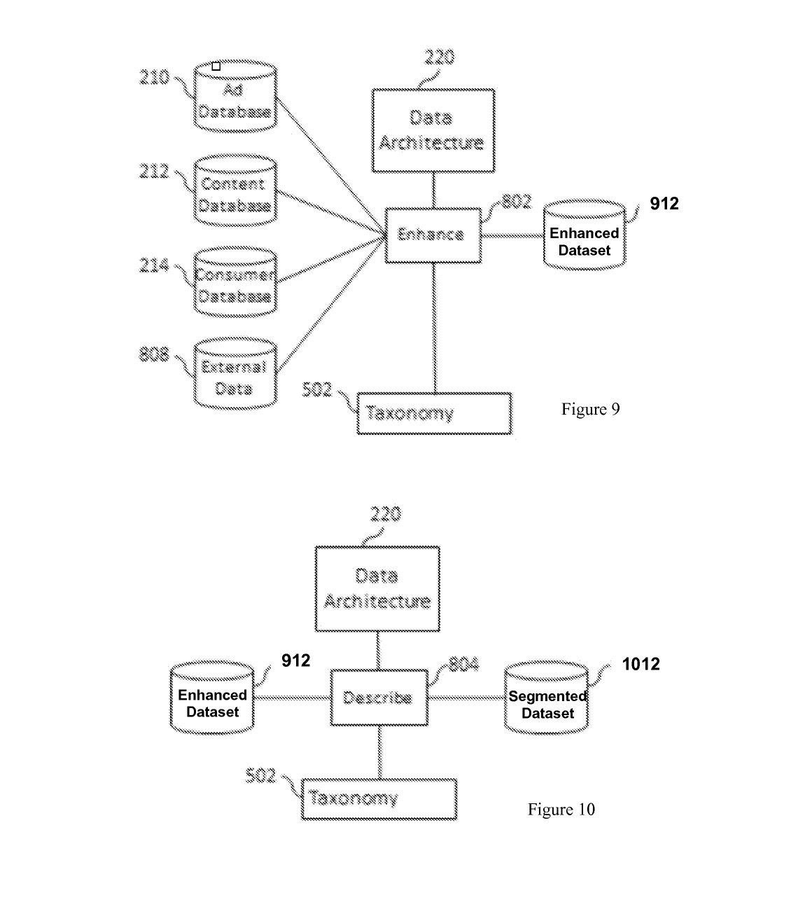

Referring now to FIGS. 4, 8, 9, 10, and 11, in one embodiment, as will be discussed in more detail below, the scoring module 110 may comprise a predictive model and the predictive model interface 406 may connect the predictive model with the various database interfaces 402 as well as the ad server interface 404. The database interfaces 402 may connect the scoring module 110 with the advertisement 210, content 212, consumer 214, and ad-consumer match data databases 216. The database interface 402 may send and receive data to and from the advertisement database 210, the content database 212, the consumer database 214, and/or the ad-consumer match data database 216 by receiving or sending data from and to the predictive model interface 406. The predictive model interface 406 may then send and receive the data to and from the scoring module 110.

In one embodiment, the ad server interface 404 may send and receive data to and from the advertisement database 210 by receiving or sending data from and to the predictive model interface 406, which in turn may send and receive data to and from the scoring module 110.

Now referring to FIGS. 8, 9, and 12, the scoring module 110 may first retrieve (or otherwise receive) data (1212) from the advertisement database 210, content database 212, consumer database 214, and/or external data 808. Next, the retrieved data (1212) may undergo an enhance stage (1202). The enhance stage (1202) may comprise enhancing the data retrieved (1212) by the scoring module 110 from the various databases 210, 212, 214 with external data 808 such as U.S. Census data, address verification and cleansing, neighborhood credit information, individual credit scores, average neighborhood income, regional buying and/or viewing habits, and the like, to provide additional insight regarding the population of users, a subpopulation of user, and/or one or more individual users. The enhance stage (1202) may be performed by an enhance module 802, which may comprise any suitable hardware and/or software system and/or method configured to enhance (1202) the retrieved (1212) data. The output of the enhance module 802 may be referred to as an enhanced dataset 912. As used herein, “data set” and “dataset” are synonymous.

For example, the predictive advertising engine 100 may store data related to the user such as their name, address, phone number, etc, such as in the consumer database 214. Using this user-provided data, the enhance module 802 may perform a database match with the external data source 808, such as a 3^{rd} party database system, to gather additional data related to the user. For example, given the user's address, the enhance module 802 may reference one or more databases that contain credit scores, average neighborhood credit scores, average income, average neighborhood incomes, average neighborhood age, number of children, average number of children, and the like, for a population near or around the user's address. For example, given the user's name and address, the enhance module 802 may reference a credit score database to retrieve the user's credit score, and may reference a U.S. census database to retrieve census information about the user. Retrieving such external data will help create a more detailed synopsis of the user. For further example, the enhance module 802 may match any suitable combination of name, address, and/or other such information for a user with the data in the external data source 808 to find and retrieve more descriptive information about the user. In other embodiments, the enhance module 802 may use both user-provided data as well as non-user provided data (e.g., data related to a user's interactions with an advertisement, commercial, and/or questionnaire, and/or data from other sources), or solely non-user provided data, to gather additional information. In other embodiments, additional data related to the user may be gathered by other methods besides a database match.

The enhanced dataset 912 may be stored in any suitable manner. In one embodiment, the enhanced dataset 912 may be stored in the consumer database 214. In another embodiment, the enhanced dataset 912 may be stored in a separate database. For example, during the enhance stage (1202) performed by the enhance module 802, results of the enhance module 802 may be stored in an aggregate consumer data database. After the enhance stage (1202), the enhanced dataset 912 may be cleansed, removed, or otherwise deleted. In other embodiments, the enhanced dataset 912 may be stored beyond the enhance stage (1202) for use at a later time.

Referring now to FIGS. 8, 10, and 12, in one embodiment, following the enhance stage (1202), the retrieved data (1212) may undergo a describe stage (1204). During the describe stage (1204), descriptive statistics may be applied to the enhanced dataset 912 to define (e.g. create and/or update) segments within the consumer population. The descriptive statistics may comprise sums, averages, frequencies, distributions, standard deviations, and the like. During the describe stage (1204), the scoring module 110 may identify which segments the user belongs in. The describe stage (1204) may be performed by a describe module 804, which may comprise any suitable hardware and/or software system and/or method configured to define segments of the consumer population and/or identify which segments the user belongs in. The output of the describe module 804 may be referred to as a segmented dataset 1012. The segmented dataset 1012 may comprise the enhanced dataset 912 plus the identified segments.

For example, the system may look at the frequency and distribution of user age to define an age segment that groups the population into ranges (e.g., 18-25, 26-35, 36-42, etc.). The predictive advertising engine 100 may further break down a segment in sub-segments. For example, within the segment of users aged 18-25, there may be a sub segment of users who are male or female. In one embodiment, any statistically significant correlation between the data in the consumer database 214 (e.g. the user data) and the likelihood of purchasing an advertised item (whether based on historical purchases, an indication of a likelihood to buy, etc.) may become a candidate for a new segment/sub-segment. The user data may be reviewed in real-time, at or upon expiration of predetermined timing intervals, manually, and the like, to update the various segments/sub-segments.

Further, any statistically significant correlation between the data in the advertisement database 210 and/or content database 212 and the likelihood of purchasing an advertised item may become a candidate for a new segment/sub-segment. For example, if there is a strong correlation between the percentage of time a user watches sports content and their likelihood of purchasing a sports-related item (e.g. exchanging money, reward points, and/or the like for the item), a segment may be created for the percentage of time a user watches sports content. For further example, if there is a strong correlation between the percentage of time a user likes a fashion-related advertisement and their likelihood of purchasing clothes, a segment may be created for the percentage of time a user likes a fashion advertisement. The segments may therefore be based on historical information such as declared consumer preferences, consumer clicks, shows the consumer watched, census information, and the like. The correlation may be determined by the scoring module 110, as discussed below.

Once the segments are created and/or updated, the describe module 804 may identify which of the various segments the user belongs in (e.g. user watches sports content 25% of the time and so belongs in the segment of users who watch sports 15-40% of the time). The identification of which segments the user belongs in may or may not be done in conjunction with creating and/or updating the segments.

By running descriptive statistics (1204) on the user population, the scoring module 110 may be able to identify patterns within certain groups which may allow the scoring module 110 to later use the data and make more accurate likelihood to purchase predictions. For example, people in the age group of 18-25 may be more likely to purchase a sports car than people in the age group of 36-42. Similarly, the predictive advertising engine 100 may indicate that users living closer to a major city may be more likely to purchase tickets to the symphony than those users who live further away from a major city.

The descriptive statistics may be applied (1204) at any time to the entirety of the group of users or only to a certain subset of users. If application of the descriptive statistics leads to the creation and/or updating of a segment, the scoring module 110 may identify which of the new and/or updated segments one, some, or all users belong in. Over time, it may be the case that certain descriptive statistics are better than others at identifying the likelihood to purchase certain items. For example, age groups may be a better indicator for car purchase than proximity to a major city whereas the opposite may be true for the purchase of symphony tickets. Such metrics may be provided by the predictive advertising engine 100 to an entity such as the advertiser and/or content provider. Entities using the predictive advertising engine 100 such as advertisers and content providers may use these metrics to adjust their content and/or campaigns.

In one embodiment, after the enhanced dataset 912 has been subjected to the describe stage (1204), the created and/or updated segments may be stored in a segment definition table, for example as shown in FIG. 14G. After the enhanced dataset 912 has been subjected to the describe stage (1204), the identified segments for the user may be stored in the consumer database 214, for example as shown in FIG. 14H.

After the retrieved data has been processed by the describe module 804, the segmented dataset 1012 may then be subjected to a predict stage (1206) as shown in FIGS. 11 and 12. The predict stage (1206) may comprise determining (e.g. calculating) a score corresponding to the user's likelihood to purchase one, some, or all products represented in the advertisement database 210. The predict module 806 may comprise any suitable hardware and/or software system and/or method configured to perform the predict stage (1206). In one embodiment, the predict stage (1206) may comprise scoring a user on their likelihood to purchase each product represented in the advertisement database 210. In other words, the user may be scored on their likelihood to purchase the advertised item of every advertisement in the advertisement database 210. In one embodiment, the predict stage (1206) may comprise scoring the user on their likelihood to purchase the advertised item of a subset advertisements in the advertisement database 210.

In one embodiment, the predict module 806 may comprise a predictive model configured to input the segmented dataset 1012 and output a likelihood to purchase score. The predictive model may be determined (e.g. created and/or updated) according to one or more techniques, such as linear regression models, discrete choice models, discriminate function analysis, logistic regression, multinomial logistic regression, probit regression, logit versus probit, time series models, survival or duration analysis, classification and regression trees, multivariate adaptive regression splines, and the like. These techniques may be applied to the segmented dataset 1012 to determine the predictive model. The predictive model may be determined in real time (e.g. upon any change of user data, advertisement data, content data, or external data, upon a request by the ad widget 104 for an advertisement, and the like), at or upon expiration of a predetermined interval (e.g. nightly, hourly, and the like), infrequently, at a manually determined time, and the like. Once the predictive model is determined, the segmented dataset 1012 may be run through the predictive model to determine the user's likelihood to purchase scores for all (or a subset of) advertised item in the advertisement database 210.

The enhanced dataset 912 and/or segmented dataset 1012 may contain many data points for the user that may or may not be used by the scoring module 110 to determine the user's likelihood to purchase an item. For example, certain types of data may be more or less indicative of the likelihood to purchase score than other types of data. The scoring module 110, such as via the predict module 806, may provide the determination of how useful each type of data is in determining (1206) the user's likelihood to purchase score. For example, if the predictive model comprises a linear regression model, the determination of how useful each type of data is may be performed by checking the statistical significance of the coefficients of the predictive model using the t-statistic, and checking how well the each data type (e.g. the independent variable) predicts the likelihood to purchase score (e.g. the dependent variable) using the R² statistic.

In one embodiment, only those types of data which provide more insight into purchase probability may be provided to the predict module 806. It may also be the case that over time certain types of data become more or less useful in determining a user's likelihood to purchase score. The predictive advertising engine 100 may be configured to allow certain types of data to be given higher weight in calculating likelihood to purchase than other types of data. The predictive advertising engine 100 may be configured to alter, over time, the weights of the various types of data, and/or which of the various types of data are used by the predict module 806.

In one embodiment, the predictive model may comprise a commercially available statistical software suite such as IBM® SPSS and/or SAS/STAT®. In one embodiment, the scoring module interface 108, such as via the predictive model interface 406, may be configured to interface with such a software suite. The predictive model interface 406 may be configured to convey, send, and/or receive data to and/or from the statistical software suite in a format that is recognized by both the statistical software suite and the ad server and portals 102. For example, the various databases 210, 212, 214 may store data in a different format than used by the software suite, and to use the data captured by the system, the data may first need to be converted into a format that the software suite can process. The software suite may be configured to accept the entirety of the data collected by the system. The software suite may be configured to accept a sub-set of the data collected. For example, certain statistical algorithms may require certain data related to the user's biographical information while other statistical algorithms may require certain data related to the user's viewing habits (e.g., content viewed, advertisements liked, advertisements opted-in/out, and/or items placed into the user's wish list). Configuring or otherwise customizing the inputs/outputs of the software suite may result in a better predictive model and may enable the system to make a more accurate prediction as to the user's likelihood to purchase an advertised item.

As described, determining the predictive model may comprise running one or more of the above techniques against the segmented dataset 1012 to determine a correlation between the data in the segmented dataset 1012 and purchasing behavior. Purchasing behavior may refer to the user redeeming reward points to acquire a specific product, purchasing the specific product, indicating that they are likely to buy the product, and the like. For example, if there is a strong correlation between people that redeem points for purple widgets and people that are age 18-25, living in or close to major cities, in neighborhoods with income ranging from $30,000-$40,000, then people with those demographic segments will be scored, by the predictive model, as having a high likelihood of acquiring a purple widget, and advertisements for purple widgets may be displayed more frequently by the predictive advertising engine 100 for people with that demographic segmentation.

In addition to using the listed techniques, the predictive model may also have the ability to “learn” on its own. Several learning techniques that may be implemented include, but are not limited to, neural networks, multilayer perceptron, radial basis functions, support vector machines, Naïve Bayes, k-nearest neighbors, and/or geospatial predictive modeling. Learning techniques may be based on any data within the predictive advertising engine such as user data, advertisement data, content metadata, the segmented dataset 1012, and the like.

In one embodiment, the result of the predictive model is stored in the ad-consumer match data database 216, with each consumer having a score for each ad representing their likelihood of purchasing the advertised item. The ad server 202 may then select the advertisements to be displayed to each user based on the user's score.

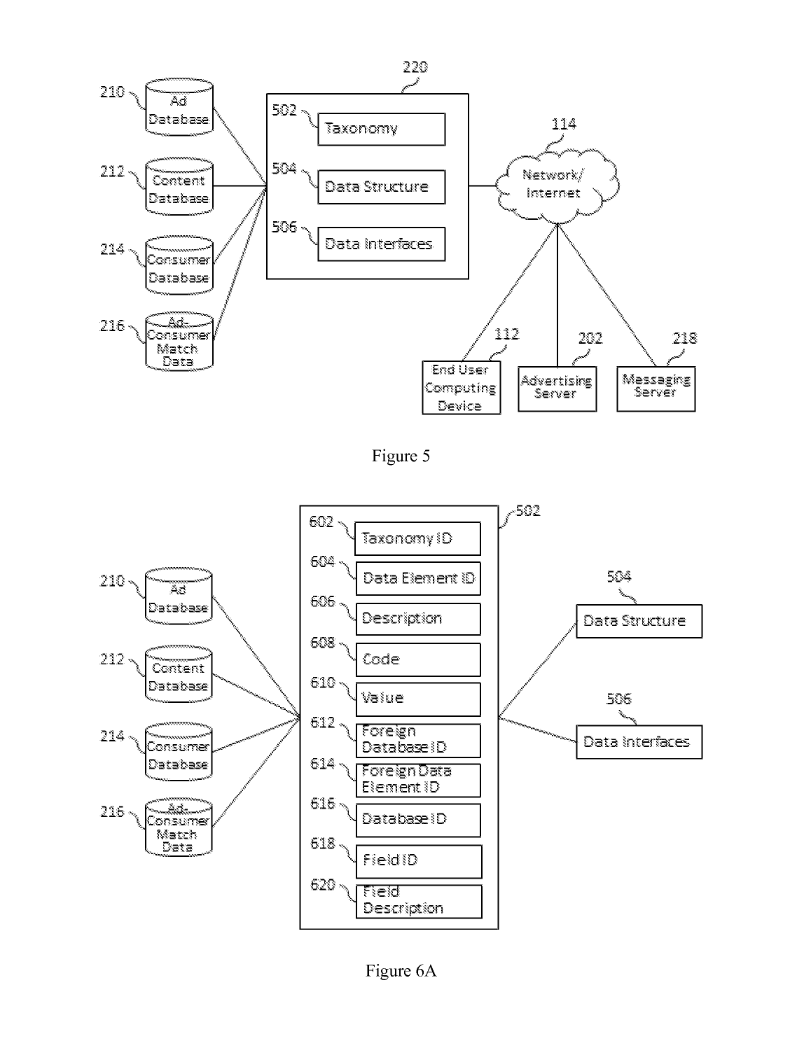

Referring now to FIG. 5, a taxonomy 502 module may describe one or more codes used to represent metadata within the advertisement 210, content 212, and consumer 214 databases. The taxonomy 502 module may ensure that data used by the predictive advertising engine 100 conforms to a certain set of rules, ensure that external data imported into the predictive advertising engine 100 follows a certain set of rules, ensure that data being exported out of the predictive advertising engine 100 follows a set of rules, and the like.

For example, referring to FIG. 5, the taxonomy 502 may define the codes X, Y, Z. A data structure 504 defines the table, record, and data element layouts and valid values for the advertisement 210, content 212, consumer 214, and ad-consumer match data 216 databases. A data interface 506 may be hardware and/or software configured to facilitate the sending and receiving of data to and from the advertisement 210, content 213, consumer 214, and ad-consumer match data 216 databases.

The taxonomy 502 may interact with the data structure 504 and the data interface 506 to validate data that is recorded into the advertisement 210, content 212, consumer 214, and ad-consumer match data databases 216. The taxonomy 502 may further interact with the advertiser 204, content provider 206, and consumer portals 208 to validate data that may be entered into those portals.

In one embodiment, related data may be linked from each database such that each related element contains the same value regardless of which database it resides on. For example, user-submitted user data may be stored in a first database. A second database may store the number of reward points associated with each user. Finally, a third database may include each user's likelihood to purchase score for an advertisement. For these three separate databases to communicate and share data between each other, the predictive advertising engine 100 may require them to share a common link. In this example, the common link may be the user ID. Because each user is identified by a unique user ID, the system may link all three separate databases together. In other words, the system may link the first database containing the user's data to the second database containing the reward points for that user through their user ID. Likewise, the predictive advertising engine 100 may determine which advertisement to deliver to the user by linking the user ID from the first database (user data) to the user ID of the third database (scored advertisements).

The ability to link multiple databases together through a common element allows the system to function more dynamically. Instead of a few large databases containing massive amounts of data, the system may be broken down into smaller databases. This allows the predictive advertising engine 100 to both retrieve and store data faster and provide the overall system more flexibility and scalability. This technique enables the scoring module 110 to score consumers on every permutation of data contained in these three databases.

The data structure 504 defines the table, record, and data element layouts and valid values for the advertisement, content, consumer, and ad-consumer match data databases. The data structure 504 incorporates the taxonomy 502 and the data interface 506 to control how data is sent and received.

The data interface 506 may comprise hardware and/or software configured to facilitate the sending and receiving of data to and from the advertisement 210, content 212, consumer 214, and ad-consumer match data 216 databases. The data interface 506 send and receive data to the various databases according to the structure and validation rules defined by the taxonomy 502 and the data structure 504.

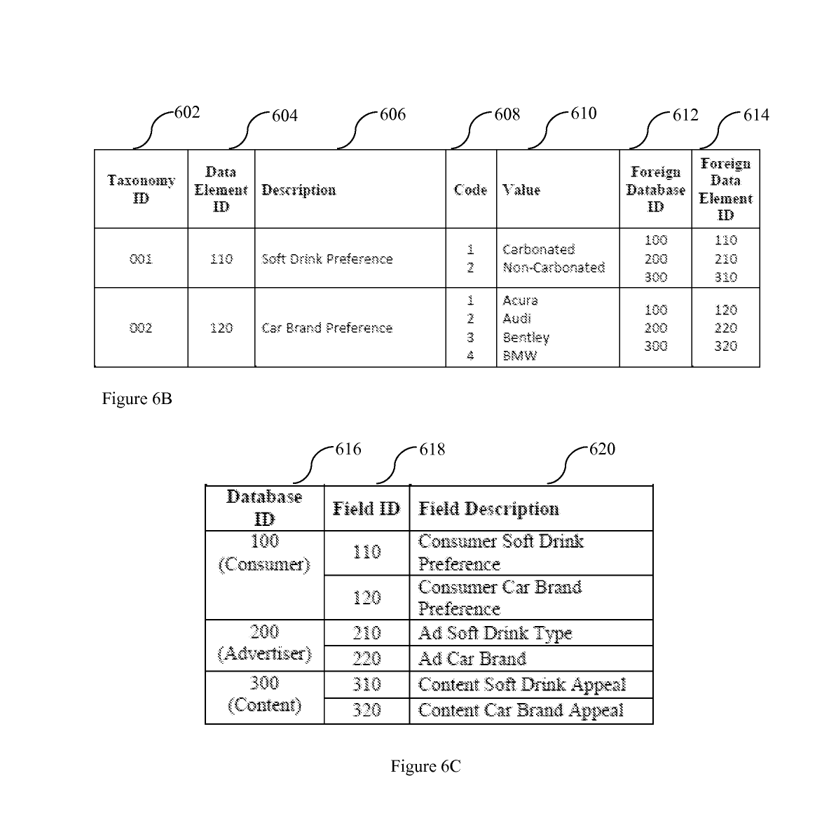

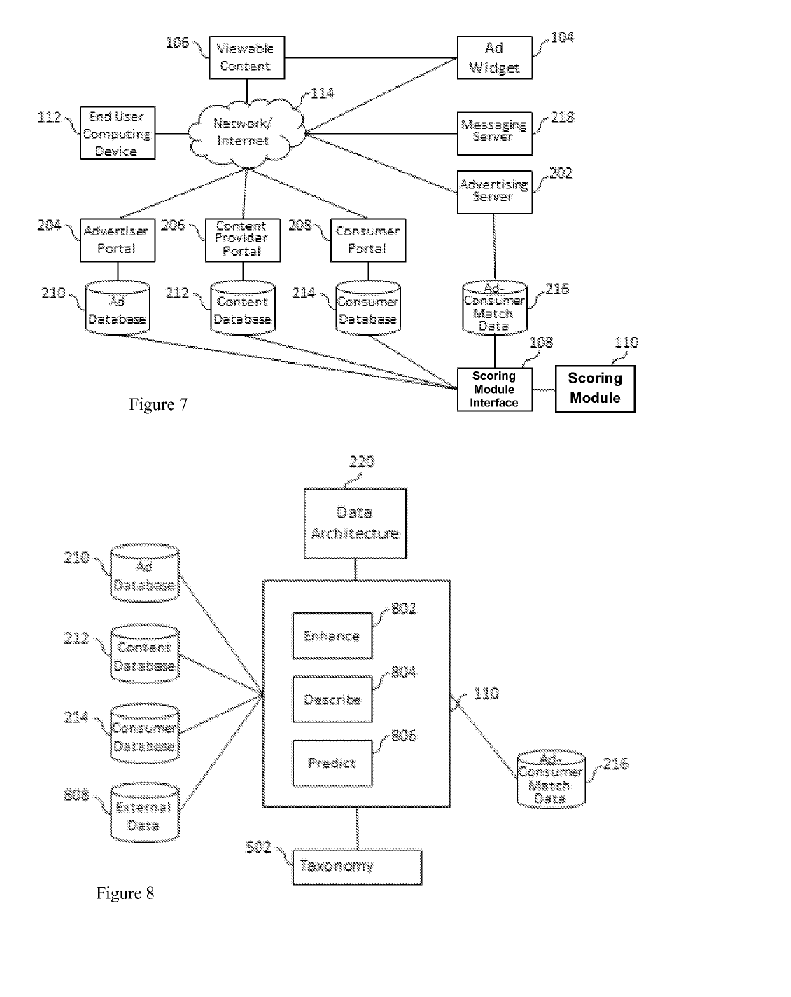

Referring now to FIGS. 6A, 6B, and 6C, the taxonomy 502 may define how data is stored within the system. A taxonomy ID 602 may be a unique identifier for a specific code set such as “soft drink preference” and “car brand preference.” The taxonomy ID 602 may be combined with a data element ID 604 and/or a code 608 to specify a unique value that may appear on one or more databases including, but not limited to, the advertisement database 210, the content database 212, the consumer database 214, and the ad-consumer match data database 216. The data element ID 604 may be a unique identifier for a coded data item. The data element ID 604 may be a second level index, subordinate to the taxonomy ID 602 to aide in identifying a data element within the code 608.

A description 606 may be a name or description of the coded data item. The description 606 may be used to describe the name and/or purpose of a data element identified by the data element 604 and may be provided for convenience in referencing data elements. The code 608 may be a unique alphanumeric value assigned to a data element. The code 608 may be a third level index, subordinate to the taxonomy ID 602 and the data element ID 604, to aide in identifying an allowed value for a data element within the code 608. A value 610 may be a plain language translation of the code 608 and may be used for display purposes on the end user computing device 112 and/or any other computing device 1300 of the predictive advertising engine 100.

A foreign database ID 612 may be a unique alphanumeric code that links to a database that uses a particular data element. The foreign database ID 612 may be linked to the taxonomy ID 602, the data element ID 604, and the advertisement 210, content 212, consumer 214, and ad-consumer match data databases 216. Foreign data element ID 614 may be a unique alphanumeric code that links to a specific data item within a given database. The foreign data element 614 may link the taxonomy ID 602 and the data element ID 604 to a specific data element on the advertisement database 210, the content database 212, and/or the consumer database 214 using the data structure 504 and the data interfaces 506.

The database ID 616 may be a unique alphanumeric code that identifies a specific database. The database ID 616 may uniquely identify the advertisement 210, content 212, and/or consumer 214 databases. The database ID 616 may also be used to link the foreign database ID 612 to specific data elements using the data structure 504 and the data interfaces 506. Field ID 618 may be a unique alphanumeric code that identifies a specific data element within a database. The field ID 618 may uniquely identify a data element within the advertisement 210, content 212, and/or consumer 214 databases to link the foreign database ID 612 to specific data elements using the data structure 504 and the data interfaces 506. A field description 620 may be a name or description of a data element within a specific database. The field description 620 may be used to describe the name and purpose of a data element identified by the field ID 618 and may be provided for convenience in referencing data elements.

Each unique taxonomy ID 602 may be associated with a unique data element ID 604. For example, taxonomy ID 001 may be associated with only the data element ID 110 and the taxonomy ID 004 may be associated with only the data element ID 140. In this example, the description 606 associated with taxonomy and data element ID pairing of 001 and 110 yields “soft drink preference.” Associated with this specific description is the code 608 which takes the value of “1” or “2” wherein each code may be associated with the value 610. In this example, the code of “1” is associated with a value of “carbonated.” This shows that the consumer has indicated his soft drink preference (from the description 606) to be carbonated. Furthering the example, if the consumer indicated that they preferred non-carbonated soft drinks, the code would be “2.”

Accordingly, the data stored in the advertisement database 210, content database 212, consumer database 214, ad-consumer match data database 216, and any related database, may be coded according to the taxonomy such that any characteristic or attribute that describes any consumer, ad, or content may also describe any other consumer, ad, or content. This technique enables the scoring module 110 to score consumers on every permutation of data contained in these databases, thus providing highly reliable predictions of individual purchasing behaviors.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the invention has been described with reference to specific exemplary embodiments. Various modifications and changes may be made, however, without departing from the scope of the present invention as set forth. The description and figures are to be regarded in an illustrative manner, rather than a restrictive one and all such modifications are intended to be included within the scope of the present invention. Accordingly, the scope of the invention should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present invention and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A method, implemented by a computer, having a processor and a memory accessible by the processor, for determining a user's likelihood to purchase an item, comprising:
retrieving, by the computer, a plurality of data, wherein the plurality of data comprises:
a first data associated with an advertisement;
a second data associated with a content; and
a third data associated with the user;
enhancing, by the computer, the retrieved data into an enhanced dataset according to an external data;
applying, by the computer, descriptive statistics to the enhanced dataset to create a segmented dataset;
providing a first set of inputs to a predictive model according to the segmented dataset;
calculating a score with the predictive model, wherein the score corresponds to the user's likelihood to purchase the item; and
storing, by the computer, the score in a first database.

2. A method for determining a user's likelihood to purchase an item according to claim 1, further comprising:
receiving, by the computer, a request for an advertisement to be presented to the user;
selecting, by the computer, the advertisement to be presented based on the score; and
transmitting, by the computer, an indication of the selected advertisement.

3. A method for determining a user's likelihood to purchase an item according to claim 1, further comprising:
recording, by the computer, an interaction of the user with the advertisement, wherein the interaction comprises at least one of selecting an advertisement, liking an advertisement, ignoring an advertisement, and opting-out of an advertisement; and
updating, by the computer, the third data associated with the user based on the recorded interaction with the advertisement.

4. A method for determining a user's likelihood to purchase an item according to claim 3, further comprising:
updating the score, wherein updating the score comprises:
retrieving, by the computer, the updated third data associated with the user;
enhancing, by the computer, the updated third data associated with the user into an enhanced updated user dataset according to the external data;
applying, by the computer, descriptive statistics to the enhanced updated user dataset to create a segmented updated user dataset;
providing a second set of inputs to the predictive model according to the segmented updated user dataset;
calculating a second score with the predictive model, wherein the second score corresponds to the user's updated likelihood to purchase the item; and
storing, by the computer, the second score in the first database.

5. A method for determining a user's likelihood to purchase an item according to claim 4, wherein updating the score is performed in response to at least one of the user's interaction and the expiration of a predetermined interval.

6. A method for determining a user's likelihood to purchase an item according to claim 2, further comprising:
presenting, by the computer, a first commercial associated with the selected advertisement;
presenting, by the computer, a first questionnaire associated with the first commercial; and
updating, by the computer, the third data associated with the user based on the user's interaction with at least one of the selected advertisement, the first commercial, and the first questionnaire.

7. A method for determining a user's likelihood to purchase an item according to claim 6, further comprising:
crediting, by the computer, reward points to the user in response to the user's interaction with at least one of the first advertisement, first commercial, and first questionnaire; and
facilitating, by the computer, the user's exchange of reward points for a reward.

8. A non-transitory computer-readable medium storing computer-executable instructions for determining a user's likelihood to purchase an item, wherein the instructions are configured to cause a computer to:
retrieve a plurality of data, wherein the plurality of data comprises:
a first data associated with an advertisement;
a second data associated with a content; and
a third data associated with the user;
enhance the retrieved data into an enhanced dataset according to an external data;
apply descriptive statistics to the enhanced dataset to create a segmented dataset;
provide a first set of inputs to a predictive model according to the segmented dataset;
calculate a score with the predictive model, wherein the score corresponds to the user's likelihood to purchase the item; and
store the score in a first database.

9. A non-transitory computer-readable medium according to claim 8, wherein the instructions are further configured to cause the computer to:
receive a request for an advertisement to be presented to the user;
select the advertisement to be presented based on the score; and
transmit an indication of the selected advertisement.

10. A non-transitory computer-readable medium according to claim 8, wherein the instructions are further configured to cause the computer to:
record an interaction of the user with the advertisement, wherein the interaction comprises at least one of selecting an advertisement, liking an advertisement, ignoring an advertisement, and opting-out of an advertisement; and
update the third data associated with the user based on the recorded interaction with the advertisement.

11. A non-transitory computer-readable medium according to claim 10, wherein the instructions are further configured to cause the computer to update the score, wherein updating the score comprises:
retrieving the updated third data associated with the user;
enhancing the updated third data associated with the user into an enhanced updated user dataset according to the external data;
applying descriptive statistics to the enhanced updated user dataset to create a segmented updated user dataset;
providing a second set of inputs to the predictive model according to the segmented updated user dataset;
calculating a second score with the predictive model, wherein the second score corresponds to the user's updated likelihood to purchase the item; and
storing the second score in the first database.

12. A non-transitory computer-readable medium according to claim 11, wherein the instructions are further configured to cause the computer to update the score in response to at least one of the user's interaction and the expiration of a predetermined interval.

13. A non-transitory computer-readable medium according to claim 9, wherein the instructions are further configured to cause the computer to:
present a first commercial associated with the selected advertisement;
present a first questionnaire associated with the first commercial; and
update the third data associated with the user based on the user's interaction with at least one of the selected advertisement, the first commercial, and the first questionnaire.

14. A non-transitory computer-readable medium according to claim 13, wherein the instructions are further configured to cause the computer to:
credit reward points to the user in response to the user's interaction with at least one of the first advertisement, first commercial, and first questionnaire; and
facilitate the user's exchange of reward points for a reward.

15. A computer system comprising a processor, and a memory responsive to the processor, wherein the memory stores instructions configured to cause the processor to:
retrieve a plurality of data, wherein the plurality of data comprises:
a first data associated with an advertisement;
a second data associated with a content; and
a third data associated with the user;
enhance the retrieved data into an enhanced dataset according to an external data;
apply descriptive statistics to the enhanced dataset to create a segmented dataset;
provide a first set of inputs to a predictive model according to the segmented dataset;
calculate a score with the predictive model, wherein the score corresponds to the user's likelihood to purchase the item; and
store the score in a first database.

16. A computer system according to claim 15, wherein the instructions are further configured to cause the processor to:
receive a request for an advertisement to be presented to the user;
select the advertisement to be presented based on the score; and
transmit an indication of the selected advertisement.

17. A computer system according to claim 15, wherein the instructions are further configured to cause the processor to:
record an interaction of the user with the advertisement, wherein the interaction comprises at least one of selecting an advertisement, liking an advertisement, ignoring an advertisement, and opting-out of an advertisement; and
update the third data associated with the user based on the recorded interaction with the advertisement.

18. A computer system according to claim 15, wherein the instructions are further configured to cause the processor to update the score, wherein updating the score comprises:
retrieving the updated third data associated with the user;
enhancing the updated third data associated with the user into an enhanced updated user dataset according to the external data;
applying descriptive statistics to the enhanced updated user dataset to create a segmented updated user dataset;
providing a second set of inputs to the predictive model according to the segmented updated user dataset;
calculating a second score with the predictive model, wherein the second score corresponds to the user's updated likelihood to purchase the item; and
storing the second score in the first database.

19. A computer system according to claim 18, wherein the instructions are further configured to cause the processor to update the score in response to at least one of the user's interaction and the expiration of a predetermined interval.

20. A computer system according to claim 16, wherein the instructions are further configured to cause the processor to:
present a first commercial associated with the selected advertisement;
present a first questionnaire associated with the first commercial; and
update the third data associated with the user based on the user's interaction with at least one of the selected advertisement, the first commercial, and the first questionnaire.

21. A computer system according to claim 20, wherein the instructions are further configured to cause the processor to:
credit reward points to the user in response to the user's interaction with at least one of the first advertisement, first commercial, and first questionnaire; and
facilitate the user's exchange of reward points for a reward.
